(19) United States
(12) Patent Application Publication
(10) Pub. No.: US 2025/0246372 A1
(43) Pub. Date: Jul. 31, 2025

(54) CERAMIC ELECTRONIC DEVICE AND MANUFACTURING METHOD OF THE SAME

(71) Applicant: TAIYO YUDEN CO., LTD., Tokyo (JP)

(72) Inventors: Takayuki FUJITA, Tokyo (JP); Hirotaka OHNO, Tokyo (JP)

(73) Assignee: TAIYO YUDEN CO., LTD., Tokyo (JP)

(21) Appl. No.: 19/182,818

(22) Filed: Apr. 18, 2025

Related U.S. Application Data
(63) Continuation of application No. PCT/JP2023/039903, filed on Nov. 6, 2023.

(30) Foreign Application Priority Data
Nov. 8, 2022 (JP) 2022-178976

(51) Int. Cl. H01G 4/30; H01G 4/012; H01G 4/12

(52) U.S. Cl. CPC H01G 4/30; H01G 4/12; H01G 4/012

(57) ABSTRACT

A ceramic electronic device includes a multilayer chip in which each of a plurality of dielectric layers and each of a plurality of internal electrode layers are alternately stacked. σ≤d_{AVE}×0.25 is satisfied when an average value of long diameters of dielectric grains is d_{AVE} and a standard deviation of the long diameters of the dielectric grains is σ in a cross section of at least one of the plurality of dielectric layers.

### CROSS-REFERENCE TO RELATED APPLICATION

This application is a continuation application of PCT/JP2023/039903 filed on Nov. 6, 2023, which claims priority to Japanese Patent Application No. 2022-178976 filed on Nov. 8, 2022, the contents of which are herein wholly incorporated by reference.

### FIELD

A certain aspect of the present invention relates to a ceramic electronic device and a manufacturing method of the ceramic electronic device.

### BACKGROUND

Ceramic electronic devices such as multilayer ceramic capacitors are used in high-frequency communication systems, such as mobile phones. Such ceramic electronic devices have a structure in which dielectric layers and internal electrode layers are alternately stacked. This structure can be obtained, for example, by simultaneously firing a dielectric green sheet containing ceramic powder and an internal electrode pattern containing metal powder (see, for example, Japanese Patent Application Publication No. 2021-19101).

### SUMMARY OF THE INVENTION

According to an aspect of the present invention, there is provided a ceramic electronic device including: a multilayer chip in which each of a plurality of dielectric layers and each of a plurality of internal electrode layers are alternately stacked, wherein σ≤d_{AVE}×0.25 is satisfied when an average value of long diameters of dielectric grains is d_{AVE} and a standard deviation of the long diameters of the dielectric grains is o in a cross section of at least one of the plurality of dielectric layers.

According to another aspect of the present invention, there is provided a manufacturing method of a ceramic electronic device including: preparing a multilayer structure in which each of a plurality of dielectric green sheets including ceramic powder and each of a plurality of internal electrode patterns including metal powder are alternately stacked; and making a relationship of σ≤d_{AVE}×0.25 in a cross section of at least one of a plurality of dielectric layers formed from the plurality of dielectric green sheets by firing the multilayer structure, when an average value of long diameters of dielectric grains is d_{AVE} and a standard deviation of the long diameters of the dielectric grains is σ.

### BRIEF DESCRIPTION OF THE DRAWINGS

FIG. 1 illustrates a perspective view of a multilayer ceramic capacitor in which a cross section of a part of the multilayer ceramic capacitor is illustrated;

FIG. 2 illustrates a cross sectional view taken along a line A-A of FIG. 1;

FIG. 3 illustrates a cross sectional view taken along a line B-B of FIG. 1;

FIG. 4A is a cross-sectional view of a dielectric layer;

FIG. 4B illustrates a long diameter of a dielectric grain;

FIG. 5A and FIG. 5B illustrate orientation of a shape of each dielectric grain;

FIG. 6A and FIG. 6B are diagrams for explaining an effective capacity;

FIG. 7A and FIG. 7B illustrate orientation of a shape of each dielectric grain;

FIG. 8A to FIG. 8C are diagrams illustrating aspect ratios;

FIG. 9 illustrates a manufacturing method of a multilayer ceramic capacitor; and

FIG. 10A and FIG. 10B illustrate a stacking process.

### DETAILED DESCRIPTION

However, if the dielectric layer does not have sufficient density after firing, the ceramic electronic device may have insufficient mechanical strength.

A description will be given of an embodiment with reference to the accompanying drawings.

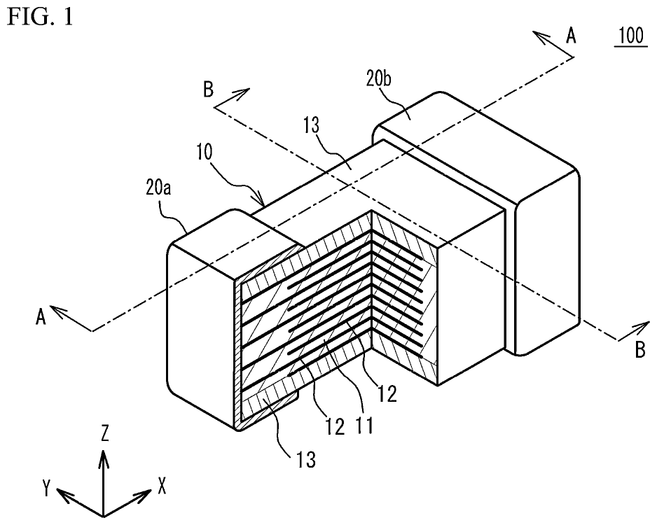

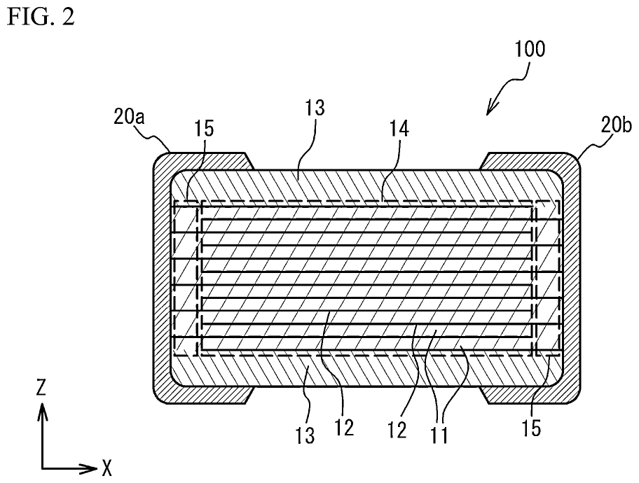

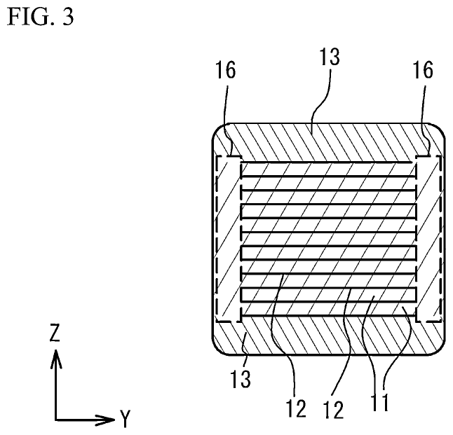

(Embodiment) FIG. 1 illustrates a perspective view of a multilayer ceramic capacitor 100 in accordance with an embodiment, in which a cross section of a part of the multilayer ceramic capacitor 100 is illustrated. FIG. 2 illustrates a cross sectional view taken along a line A-A of FIG. 1. FIG. 3 illustrates a cross sectional view taken along a line B-B of FIG. 1. As illustrated in FIG. 1 to FIG. 3, the multilayer ceramic capacitor 100 includes a multilayer chip 10 having a rectangular parallelepiped shape, and a pair of external electrodes 20a and 20b that are respectively provided at two end faces of the multilayer chip 10 facing each other. In four faces other than the two end faces of the multilayer chip 10, two faces other than an upper face and a lower face of the multilayer chip 10 in a stacking direction are referred to as side faces. The external electrodes 20a and 20b extend to the upper face, the lower face and the two side faces of the multilayer chip 10. However, the external electrodes 20a and 20b are spaced from each other.

In FIG. 1 to FIGS. 3, 1 to 3, a Z-axis direction is the direction in which the internal electrode layers 12 face each other, the stacking direction of the dielectric layers 11, and the direction in which the upper face and the lower face of the multilayer chip 10 face each other. An X-axis direction is the length direction of the multilayer chip 10, the direction in which the two end faces of the multilayer chip 10 face each other, the direction in which the external electrodes 20a and 20b face each other, and the longitudinal direction in which the dielectric layers 11 extend. A Y-axis direction is the width direction of the internal electrode layers 12, and the direction in which the two side faces other than the two end faces of the four side faces of the multilayer chip 10 face each other.

The multilayer chip 10 has a configuration in which dielectric layers 11 containing a ceramic material that functions as a dielectric and the internal electrode layers 12 of which a main component is a metal are alternately stacked. In other words, the multilayer chip 10 includes the plurality of internal electrode layers 12 facing each other, and the dielectric layers 11 sandwiched between the plurality of internal electrode layers 12. The edges of the internal electrode layers 12 in a direction in which the internal electrode layers extend are alternately exposed to the first end face of the multilayer chip 10 on which the external electrode 20a is provided and the second end face on which the external electrode 20b is provided. The internal electrode layer 12 connected to the external electrode 20a is not connected to the external electrode 20b, and the internal electrode layer 12 connected to the external electrode 20b is not connected to the external electrode 20a. As a result, each of the internal electrode layers 12 is alternately conductive to the external electrode 20a and the external electrode 20b. In addition, in the multilayer structure of the dielectric layers 11 and the internal electrode layers 12, the internal electrode layers 12 are arranged on both outermost layers in the stacking direction, and the internal electrode layers 12 of the outermost layers are covered by cover layers 13. The cover layers 13 are mainly composed of a ceramic material. For example, the cover layers 13 may have the same composition as the dielectric layers 11 or may have a different composition.

As illustrated in FIG. 2, a section, in which a set of the internal electrode layers 12 connected to the external electrode 20a face another set of the internal electrode layers 12 connected to the external electrode 20b, is a section generating electrical capacity in the multilayer ceramic capacitor 100. Accordingly, the section is referred to as a capacity section 14. That is, the capacity section 14 is a section in which the internal electrode layers next to each other being connected to different external electrodes face each other.

A section, in which the internal electrode layers 12 connected to the external electrode 20a face each other without sandwiching the internal electrode layer 12 connected to the external electrode 20b, is referred to as an end margin 15. A section, in which the internal electrode layers 12 connected to the external electrode 20b face each other without sandwiching the internal electrode layer 12 connected to the external electrode 20a is another end margin 15. That is, the end margin 15 is a section in which a set of the internal electrode layers 12 connected to one external electrode face each other without sandwiching the internal electrode layer 12 connected to the other external electrode. The end margins 15 are sections that do not generate electrostatic capacity in the multilayer ceramic capacitor 100. The end margin 15 may have the same composition as the dielectric layer 11 of the capacity section 14, or may have a different composition.

As illustrated in FIG. 3, a section of the multilayer chip 10 from the two sides thereof to the internal electrode layers 12 is referred to as a side margin 16. That is, the side margin 16 is a section covering edges of the stacked internal electrode layers 12 in the extension direction toward the two side faces. The side margin 16 does not generate electrostatic capacity. The side margin 16 may have the same composition as the dielectric layer 11 of the capacity section 14, or may have a different composition.

In such a configuration, the dielectric layer can be fired by, for example, subjecting a dielectric material containing ceramic powder to a heat treatment and sintering the ceramic powder. The dielectric layer obtained by sintering may have insufficient density. In this case, there is a risk that the dielectric layer will not have sufficient mechanical strength. Therefore, the multilayer ceramic capacitor 100 according to this embodiment has a configuration that can achieve sufficient mechanical strength.

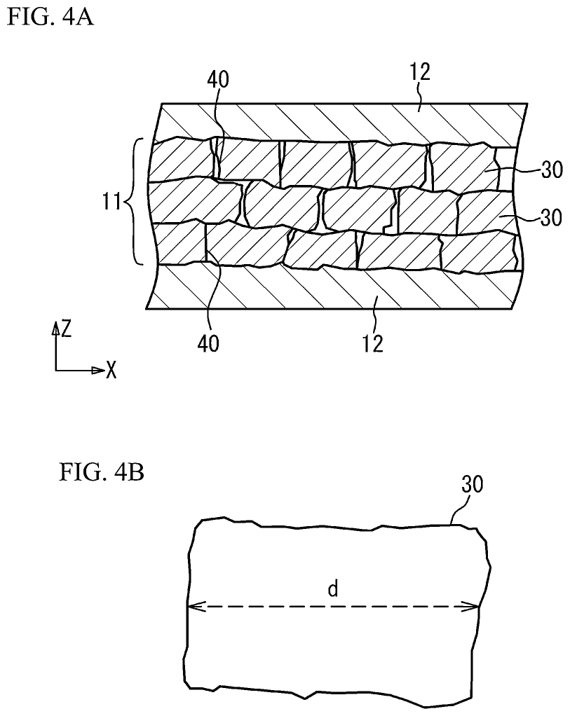

FIG. 4A is a cross-sectional view of the dielectric layer 11 along the Z-axis direction. In FIG. 4A, a cross-sectional view in the XZ plane is illustrated as an example. As illustrated in FIG. 4A, the dielectric layer 11 has a structure in which a plurality of dielectric grains 30 are sintered via grain boundaries 40. The size and shape of the plurality of dielectric grains 30 that constitute the dielectric layer 11 are similar to each other.

First, as illustrated in FIG. 4B, the long diameter of the dielectric grain 30 is taken as a long diameter “d”. The standard deviation of the long diameter “d” of the dielectric grains 30 in the dielectric layer 11 is defined as the standard deviation “σ”. The average value of the long diameters “d” of the dielectric grains 30 in the dielectric layer 11 is defined as an average value d_{AVE}. In this embodiment, a relationship is established in which the standard deviation “σ” is equal to or less than the average value d_{AVE}×0.25. In this case, of the plurality of dielectric grains 30 contained in the dielectric layer 11, approximately 66.7% or more of the crystal grains have the long diameter “d” of the average value d_{AVE}±25%. The definition of the long diameter will be described later.

With this configuration, the plurality of dielectric grains 30 constituting the dielectric layer 11 are similar in size and shape to each other. As a result, as illustrated in FIG. 4A, the gaps between the plurality of dielectric grains 30 become smaller, and the dielectric layer 11 becomes denser. The densification of the dielectric layer 11 improves the mechanical strength of the dielectric layer 11.

In order to make the size and shape of the plurality of dielectric grains 30 similar to each other, the standard deviation “σ” is preferably equal to or less than the average value d_{AVE}×0.20, and more preferably equal to or less than the average value d_{AVE}×0.17.

The long diameter “d” of all of the dielectric grains 30 in the dielectric layer 11 is preferably within a range of ±25% of the average value d_{AVE}, more preferably within a range of ±22% of the average value d_{AVE}, and even more preferably within a range of ±20% of the average value d_{AVE}.

Densifying the dielectric layer 11 suppresses the variation in the thickness of the dielectric layer 11 and makes the dielectric layer 11 flat. This also makes the two internal electrode layers 12 adjacent to the dielectric layer 11 flat. As a result, discontinuities in the internal electrode layer 12 are suppressed, and the continuity modulus of the internal electrode layer 12 is improved. For example, in the XZ cross section, the surface roughness Ra of the main surface (upper surface and lower surface) of the dielectric layer 11 is preferably 50 nm or less, more preferably 20 nm or less, and even more preferably 17 nm or less. For example, even if the main surface of the dielectric layer 11 is uneven, it is preferable that the height of the unevenness is within ± (average value of the length in the Z-axis direction of each dielectric particle 30×0.5). The surface roughness Ra is specified in ISO 25178.

The smaller the dielectric grains 30 are, the higher the density of the dielectric layer 11 is. Therefore, it is preferable to set an upper limit on the average value d_{AVE} of the long diameter “d” of the plurality of dielectric grains 30. In this embodiment, the average value d_{AVE} is preferably 120 nm or less, more preferably 100 nm or less, and even more preferably 90 nm or less.

On the other hand, if the dielectric grains 30 are too small, shrinkage during sintering may become too great, which may impair the flatness of the dielectric layer 11. Therefore, it is preferable to set a lower limit on the average value d_{AVE} of the long diameter “d” of the plurality of dielectric grains 30. In this embodiment, the average value d_{AVE} is preferably 20 nm or more, more preferably 25 nm or more, and even more preferably 35 nm or more.

As the main component of the dielectric layer 11, a ceramic material having a perovskite structure represented by the general formula ABO₃ can be used. The perovskite structure may contain ABO_{3-α} that deviates from the stoichiometric composition. For example, the ceramic material may be selected from at least one of BaTiO₃ (barium titanate), CaZrO₃ (calcium zirconate), CaTiO₃ (calcium titanate), SrTiO₃ (strontium titanate), MgTiO₃ (magnesium titanate), or Ba_{1-x-y}CaₓSr_{y}Ti_{1-z}Zr₂O₃ (0≤x≤1,0≤y≤1,0≤z≤1) which forms a perovskite structure. Ba_{1-x-y}CaₓSr_{y}Ti_{1-z}Zr₂O₃ is such as barium strontium titanate, barium calcium titanate, barium zirconate, barium titanate zirconate, calcium titanate zirconate, or barium calcium titanate zirconate.

Additives may be added to the dielectric layer 11. Examples of additives to the dielectric layer 11 is such as oxides of magnesium (Mg), manganese (Mn), molybdenum (Mo), vanadium (V), chromium (Cr), rare earth elements (yttrium (Y), samarium (Sm), europium (Eu), gadolinium (Gd), terbium (Tb), dysprosium (Dy), holmium (Ho), erbium (Er), thulium (Tm), and ytterbium (Yb)), or oxides containing cobalt (Co), nickel (Ni), lithium (Li), boron (B), sodium (Na), potassium (K), or silicon (Si), or glasses containing Co, Ni, Li, B, Na, K, or Si.

It is sufficient that the relationship σ≤average value d_{AVE}×0.25 or less is satisfied in at least one of the dielectric layers 11 included in the multilayer chip 10. For example, it is preferable that, of the dielectric layers 11 included in the multilayer chip 10, 50% or more of the dielectric layers 11 have the relationship σ≤average value d_{AVE}×0.25 or less.

The average thickness per layer of the dielectric layers 11 is, for example, 0.2 μm or more and 3 μm or less, and preferably 0.3 μm or more and 1.0 μm or less. The average thickness per layer of the dielectric layers 11 can be the average value of thicknesses measured at 10 different locations. The cross-sectional thickness can be measured using a laser microscope on the exposed surface obtained by cutting the multilayer chip 10.

The internal electrode layers 12 are mainly composed of base metals such as nickel (Ni), copper (Cu), or tin (Sn), or alloys thereof. As the main component of the internal electrode layers 12, noble metals such as platinum (Pt), palladium (Pd), silver (Ag), or gold (Au), or alloys containing these metals, may be used.

The average thickness of each of the internal electrode layers 12 is, for example, 0.2 μm or more and 3 μm or less, and preferably 0.3 μm or more and 1.5 μm or less. The average thickness of each of the internal electrode layers 12 can be the average value of thicknesses measured at 10 different locations. The cross-sectional thickness can be measured using a laser microscope on the exposed surface obtained by cutting the multilayer chip 10.

For example, the multilayer ceramic capacitor 100 may have a length of 0.25 mm, a width of 0.125 mm, and a height of 0.125 mm. The multilayer ceramic capacitor 100 may have a length of 0.4 mm, a width of 0.2 mm, and a height of 0.2 mm. The multilayer ceramic capacitor 100 may have a length of 0.6 mm, a width of 0.3 mm, and a height of 0.3 mm. The multilayer ceramic capacitor 100 may have a length of 0.6 mm, a width of 0.3 mm, and a height of 0.110 mm. The multilayer ceramic capacitor 100 may have a length of 1.0 mm, a width of 0.5 mm, and a height of 0.5 mm. The multilayer ceramic capacitor 100 may have a length of 1.0 mm, a width of 0.5 mm, and a height of 0.1 mm. The multilayer ceramic capacitor 100 may have a length of 3.2 mm, a width of 1.6 mm, and a height of 1.6 mm. The multilayer ceramic capacitor 100 may have a length of 4.5 mm, a width of 3.2 mm, and a height of 2.5 mm. However, the size of the multilayer ceramic capacitor 100 is not limited to the above sizes.

In the multilayer ceramic capacitor 100, the number of layers of the internal electrode layers 12 is, for example, about 100 layers or more and 1000 layers or less. In addition, in the multilayer ceramic capacitor 100, the stacking density of the internal electrode layers 12 is about 100 layers/mm or more and 1700 layers/mm or less.

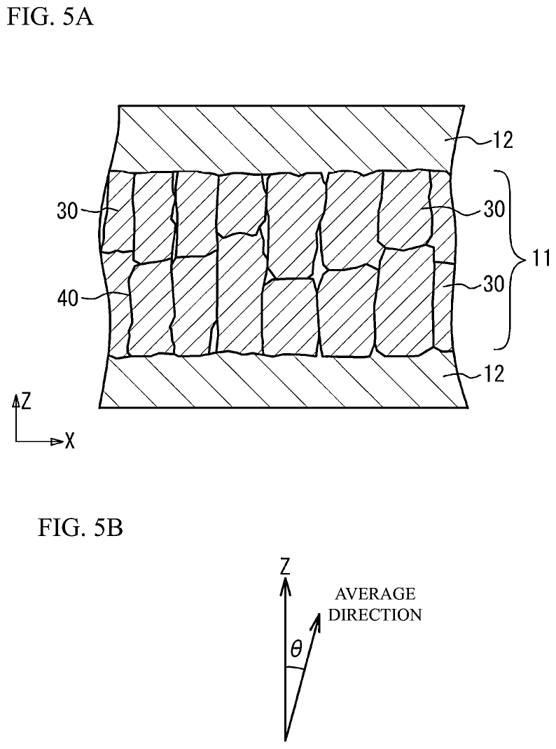

It is preferable that the shape of each of the dielectric grains 30 is oriented. For example, as illustrated in FIG. 5A, it is preferable that the angle between the long diameter direction of each of the dielectric grains 30 and the Z-axis direction is small. In this case, the crystal grains are stacked with small gaps, so that the density of the dielectric layer 11 is high.

For example, as illustrated in FIG. 5B, the average direction of the long diameter directions of the dielectric grains 30 is calculated. The angle between this average direction and the Z-axis direction is preferably ±40° or less, more preferably ±35° or less, and even more preferably ±30° or less. In addition, it is preferable that two or more dielectric grains 30 are arranged in the Z-axis direction in one dielectric layer 11.

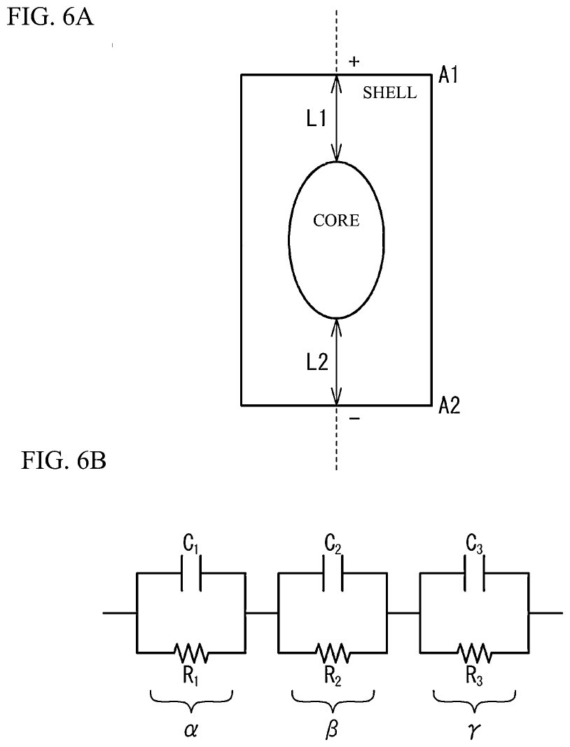

The effective capacity in the configuration of FIG. 5A will be explained with reference to FIG. 6A and FIG. 6B. The core and the shell in FIG. 6A indicate the core and the shell of the core-shell structure of the dielectric grain 30 in FIG. 5A. “α” in FIG. 6B indicates the capacity component C1 and resistance component R1 of the shell in FIG. 6A. “β” in FIG. 6B indicates the capacity component C1 and resistance component R2 of the core. “γ” in FIG. 6B indicates the capacity component C3 and resistance component R3 (opposite side of “α”) of the shell in FIG. 6A. R1 and R3 of “α” and “γ” are proportional to the distances L1 and L2 to the core and the surface areas A1 and A2 to be conducted. When considering the effective capacity, a DC voltage is superimposed. The higher the resistance components R1 and R3 are, the more the voltage applied to the core is attenuated (the capacity attenuated by the DC voltage is reduced), and the higher the effective capacity is.

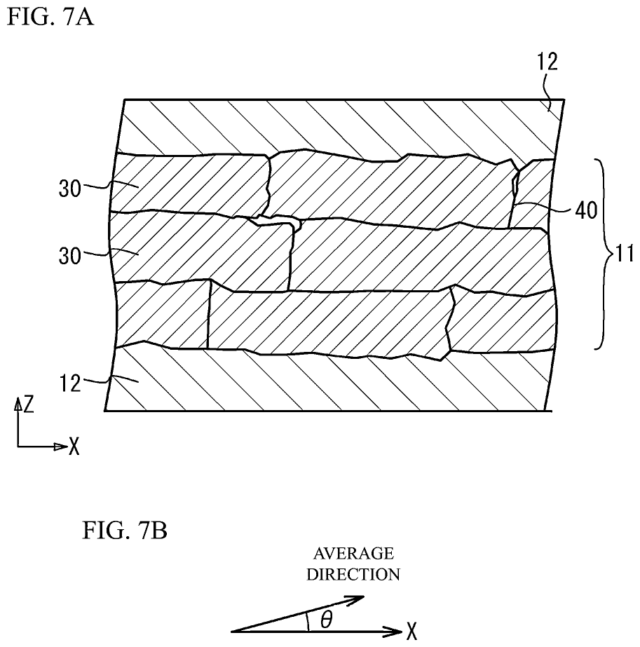

Alternatively, as illustrated in FIG. 7A, it is preferable that the angle between the long diameter direction of each of the dielectric grains 30 and the X-axis direction is small. In this case, the crystal grains are stacked with small gaps between them, so that the density of the dielectric layer 11 is increased. In addition, the dielectric layer 11 becomes flatter. In addition, the resistance of the dielectric layer 11 to bending stress is increased, so that the mechanical strength of the dielectric layer 11 is increased.

For example, as illustrated in FIG. 7B, the average direction of the long diameter directions of the dielectric grains 30 is calculated. The angle between this average direction and the X-axis direction is preferably ±40° or less, more preferably ±35° or less, and even more preferably ±30° or less.

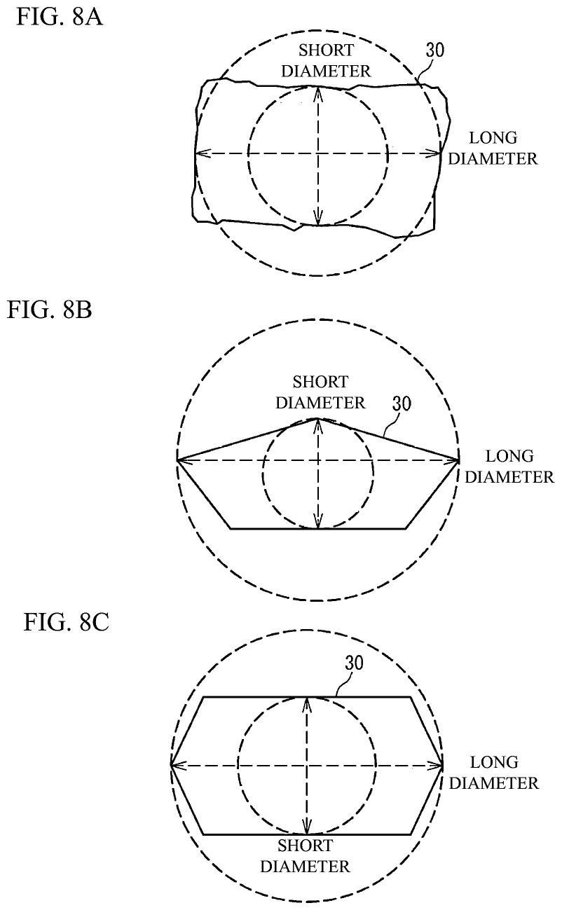

When the shape of each of dielectric grains 30 is oriented as in FIG. 5A or FIG. 7A, it is preferable that the aspect ratios of the dielectric grains 30 are close to each other. For example, it is preferable that the average value of the aspect ratio of each of the dielectric grains 30 is more than 1:1 and less than 1:5. The aspect ratio is the ratio of the short diameter to the long diameter of the dielectric grain 30, as exemplified in FIG. 8A to FIG. 8C. Here, the short diameter is the minimum value of the diameter when a circle is superimposed on the dielectric grain 30 and both ends of the diameter of the circle are superimposed on the outer shape of the dielectric grain 30. The long diameter is the diameter when a circle is superimposed on the dielectric grains 30 and both ends of the diameter of the circle are superimposed on the outer shape of the dielectric grain 30 in the direction orthogonal to the minor axis.

The long diameter “d”, the average value d_{AVE}, the standard deviation “σ”, and the average direction of the long diameter directions described above can be calculated from an SEM image of the cross section of the dielectric layer 11. For example, in an SEM image containing 100 dielectric grains 30 in an XZ cross section, the average value d_{AVE} and the standard deviation “σ” can be calculated by measuring the long diameter “d” of each of the dielectric grains 30. In addition, since the direction of the long diameter “d” of each of the dielectric grains 30 can be measured, the average direction of the long diameter directions can be calculated.

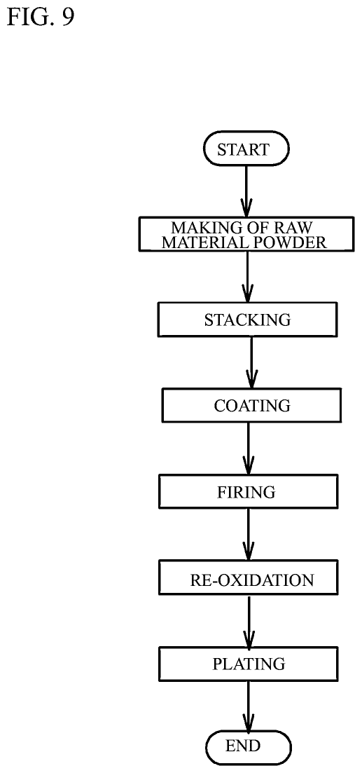

Next, a description will be given of a manufacturing method of the multilayer ceramic capacitors 100. FIG. 9 illustrates a manufacturing method of the multilayer ceramic capacitor 100.

(Raw material powder preparation process) First, the main component ceramic of the dielectric layer 11 is synthesized. For example, if the main component ceramic of the dielectric layer 11 is barium titanate, the main component ceramic can be synthesized from a titanium raw material such as titanium dioxide and a barium raw material such as barium carbonate. The synthesis method can be a solid-phase method, an oxalic acid method, a citric acid method, a hydrothermal synthesis method, a solvothermal method, or the like. Here, a process is performed to adjust the particle size distribution of the synthesized main component ceramic. For example, the synthesized main component ceramic particles are dispersed to form a slurry, and fine powder and coarse powder are removed from the obtained slurry to obtain a main component ceramic with a uniform particle size.

An additive compound may be added to the resulting ceramic powder, in accordance with purposes. The additive compound may be an oxide of magnesium (Mg), manganese (Mn), molybdenum (Mo), vanadium (V), chromium (Cr), a rare earth element (yttrium (Y), samarium (Sm), europium (Eu), gadolinium (Gd), terbium (Tb), dysprosium (Dy), holmium (Ho), erbium (Er), thulium (Tm) or ytterbium (Yb)), or an oxide containing cobalt (Co), nickel (Ni), lithium (Li), boron (B), sodium (Na), potassium (K) or silicon (Si), or glasses containing cobalt, nickel, lithium, boron, sodium, potassium or silicon. Among them, SiO₂ acts as a sintering aid.

(Stacking process) Next, a binder such as polyvinyl butyral (PVB) resin, an organic solvent such as ethanol or toluene, and a plasticizer are added to the obtained dielectric material and wet mixed. The obtained slurry is used to coat a dielectric green sheet 52 on a base material 51 by, for example, a die coater method or a doctor blade method, and then dried. The substrate 51 is, for example, a polyethylene terephthalate (PET) film. By changing the viscosity of the slurry to be applied, it is possible to control the particle orientation during forming the dielectric green sheet 52.

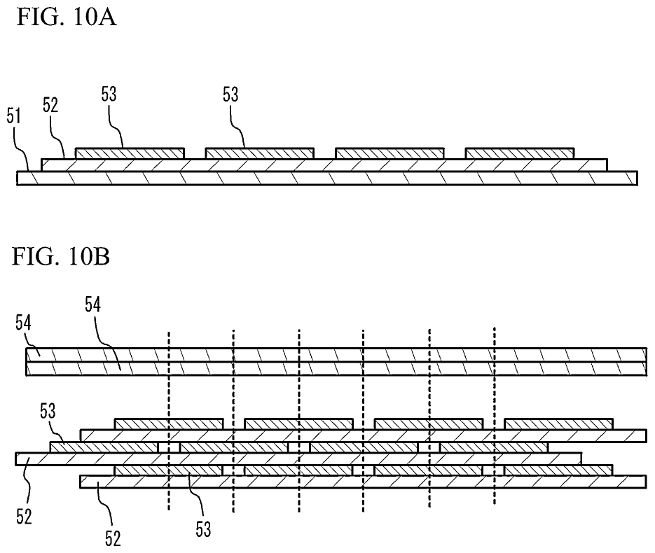

Next, as illustrated in FIG. 10A, an internal electrode pattern 53 is formed on the dielectric green sheet 52. In FIG. 10A, as an example, four layers of the internal electrode patterns 53 are formed at predetermined intervals on the dielectric green sheet 52. The dielectric green sheet 52 on which the internal electrode patterns 53 are formed is regarded as a stack unit. For the internal electrode pattern 53, a metal paste of the main component metal of the internal electrode layer 12 is used. The deposition method may be printing, sputtering, vapor deposition, or the like.

Next, while peeling the dielectric green sheet 52 from the base material 51, the stack units are stacked as illustrated in FIG. 10B.

Next, a predetermined number of cover sheets 54 (for example, 2 to 10 layers) are stacked on the top and bottom of the multilayer structure obtained by stacking the stack units, and are thermocompression bonded, and cut to the predetermined chip dimensions (for example, 1.0 mm×0.5 mm). In the example of FIG. 8C, cutting is performed along the dotted line. The cover sheet 54 may be of the same composition as the dielectric green sheet 52, or may contain different additives.

(Coating process) The ceramic multilayer structure thus obtained is subjected to a binder removal process in an N₂ atmosphere, and then a metal paste that will become the base layer of the external electrodes 20a, 20b is coated by a dipping method or the like. The metal paste contains a co-material. For example, the metal paste is coated on the two end faces of the multilayer structure where the internal electrode patterns 53 are exposed.

(Firing process) Then, the multilayer structure is fired at 1100 to 1300° C. for 10 minutes to 2 hours in a reducing atmosphere with an oxygen partial pressure of 10⁻⁵ to 10⁻⁸ atm. In this way, the multilayer chip 10 and the external electrodes 20a, 20b can be fired simultaneously. In the firing process, the cross section of the obtained dielectric layer 11 is made to have the above-mentioned relationship of standard deviation σ≤d_{AVE}×0.25.

(Re-oxidizing process) After that, a re-oxidation process may be performed in N₂ gas atmosphere in a temperature range from 600° C. to 1000° C.

(Plating process) Thereafter, a plated layer may be formed on the external electrodes 20a and 20b by plating. Through the above steps, the multilayer ceramic capacitor 100 is completed.

In the above, the external electrodes 20a, 20b and the internal electrode layers 12 are fired at the same time, but this is not limited to the above. For example, the external electrodes 20a, 20b may be baked after the internal electrode layers 12 are fired.

According to the manufacturing method of this embodiment, the ceramic particles contained in the dielectric material are similar in size and shape, so that the density of the dielectric layer 11 is improved in the multilayer chip 10 after firing. This improves the mechanical strength of the dielectric layer 11. In addition, since the ceramic particles contained in the dielectric material are similar in size and shape, the dielectric green sheet 52 is formed flat, and therefore the internal electrode pattern 53 is also formed flat. This allows the multilayer chip 10 after firing to have high reliability.

In the embodiments, the multilayer ceramic capacitor is described as an example of ceramic electronic devices. However, the embodiments are not limited to the multilayer ceramic capacitor. For example, the embodiments may be applied to another electronic device such as varistor or thermistor.

Although the embodiments of the present invention have been described in detail, it is to be understood that the various change, substitutions, and alterations could be made hereto without departing from the spirit and scope of the invention.

1. A ceramic electronic device comprising:
a multilayer chip in which each of a plurality of dielectric layers and each of a plurality of internal electrode layers are alternately stacked,
wherein σ≤d_{AVE}×0.25 is satisfied when an average value of long diameters of dielectric grains is d_{AVE} and a standard deviation of the long diameters of the dielectric grains is σ in a cross section of at least one of the plurality of dielectric layers.

2. The ceramic electronic device as claimed in claim 1, wherein a surface roughness Ra of at least one of main faces of a dielectric layer satisfying σ≤d_{AVE}×0.25 is 50 nm or less.

3. The ceramic electronic device as claimed in claim 1, wherein the d_{AVE} is 20 nm or more and 120 nm or less.

4. The ceramic electronic device as claimed in claim 1, wherein an angle between a stacking direction of the plurality of dielectric layers and an average direction of long diameter directions of the dielectric grains is ±40° or less.

5. The ceramic electronic device as claimed in claim 4, wherein an average of aspect ratios of the dielectric grains is more than 1:1 and less than 1:5.

6. The ceramic electronic device as claimed in claim 1, wherein an angle between a longitudinal direction in which the plurality of dielectric layers extend and an average direction of long diameter directions of the dielectric grains is ±40° or less.

7. The ceramic electronic device as clamed in claim 6, wherein an average of aspect rations of the dielectric grains is more than 1:1 and less than 1:5.

8. The ceramic electronic device as claimed in claim 1, wherein a main component of the dielectric grains is one of barium titanate, calcium zirconate, calcium titanate, strontium titanate, magnesium titanate, and B_{a1-x-y}CaₓSr_{y}Ti_{1-z}Zr₂O₃ (0≤x≤1,0≤y≤1,0≤z≤1).

9. The ceramic electronic device as claimed in claim 1, wherein 50% or more of the plurality of dielectric layers satisfy σ≤d_{AVE}×0.25.

10. The ceramic electronic device as claimed in claim 1, wherein an average thickness per one layer of the plurality of dielectric layers is 0.2 μm or more and 3 μm or less.

11. The ceramic electronic device as claimed in claim 1, wherein an average thickness per one layer of the plurality of internal electrode layers is 0.2 μm or more and 3 μm or less.

12. The ceramic electronic device as claimed in claim 1, wherein the plurality of internal electrode layers are alternately extracted to two end faces of the multilayer chip and alternately connected to two external electrodes.

13. A manufacturing method of a ceramic electronic device comprising:
preparing a multilayer structure in which each of a plurality of dielectric green sheets including ceramic powder and each of a plurality of internal electrode patterns including metal powder are alternately stacked; and
making a relationship of σ≤d_{AVE}×0.25 in a cross section of at least one of a plurality of dielectric layers formed from the plurality of dielectric green sheets by firing the multilayer structure, when an average value of long diameters of dielectric grains is d_{AVE} and a standard deviation of the long diameters of the dielectric grains is σ.
